(19) United States
(12) Patent Application Publication
(10) Pub. No.: US 2019/0187107 A1
(43) Pub. Date: Jun. 20, 2019

(54) METHODS FOR ULTRASONIC NON-DESTRUCTIVE TESTING USING ANALYTICAL REVERSE TIME MIGRATION

(71) Applicants: REGENTS OF THE UNIVERSITY OF MINNESOTA, Minneapolis, MN (US); University of Pittsburgh – Of the Commonwealth System of Higher Education, Pittsburgh, PA (US)

(72) Inventors: Aziz Asadollahi, Minneapolis, MN (US); Lev Khazanovich, Pittsburgh, PA (US)

(21) Appl. No.: 16/222,517

(22) Filed: Dec. 17, 2018

Related U.S. Application Data
(60) Provisional application No. 62/599,554, filed on Dec. 15, 2017.

(51) Int. Cl. G01N 29/50; G01N 29/26; G01N 29/04; G06T 7/00

(52) U.S. Cl. CPC G01N 29/50; G01N 29/26; G06T 2207/10132; G06T 7/0012; G01N 29/043

(57) ABSTRACT

Systems and methods for nondestructive testing using ultrasound transducers, such as dry point contact (“DPC”) transducers or other transducers that emit horizontal shear waves, are described. An analytical reverse time migration (“RTM”) technique is implemented to generate images from data acquired using the ultrasound transducers.

### CROSS-REFERENCE TO RELATED APPLICATIONS

This application claims the benefit of U.S. Provisional Patent Application Ser. No. 62/599,554, filed on Dec. 15, 2017, and entitled “METHODS FOR ULTRASONIC NON-DESTRUCTIVE TESTING USING ANALYTICAL REVERSE TIME MIGRATION,” which is herein incorporated by reference in its entirety.

### BACKGROUND

The emergence of linear array system with low frequency dry point contact transducers emitting horizontal shear waves offers an opportunity to improve nondestructive testing (“NDT”) of concrete structures. The small contact area of dry point contact transducers with a concrete member allows a direct contact without requiring a coupling agent; therefore, these transducers allow data to be acquired more efficiently. In comparison to transducers that transmit longitudinal waves, shear transducers enable detection of smaller defects and inclusions in deeper depths of concrete members. Detection of smaller and deeper defects are accomplished by lowering energy loss due to scattering and mode conversion. Such efficient data acquisition systems need powerful imaging techniques to exploit the acquired data.

The well-established imaging method in NDT of concrete members is synthetic aperture focusing technique (“SAFT”). SAFT is used extensively to measure thickness and to detect rebar, delamination, and damage. SAFT can provide the image of the scanned medium in a few seconds, but it suffers from some shortcomings. For instance, it comes short in locating vertical boundaries, steep cracks, and bottom boundaries of tendon ducts. Therefore, a more advanced imaging technique is needed to overcome these limitations.

Recently, a new imaging method, reverse time migration (“RTM”) technique, has gained attention in ultrasonic NDT. In contrast to SAFT, which is a ray-based technique and converts multiple reflections to artefacts, RTM takes advantage of the energy of multiple reflections for imaging, which allows it to overcome the limitations of SAFT. RTM has the potential of imaging a whole circular boundary of tendon ducts and vertical boundaries of stepped foundations, detecting defects around rebar located in a concrete medium, and locating the vertical boundary of a large stepped foundation.

Despite the aforementioned capabilities, RTM suffers from two primary bottlenecks: the method is computationally costly and it demands massive memory. RTM requires numerous numerical simulations and requires that an entire time history of the source wavefield be saved in memory or on a disk. RTM is actively being used in the oil and gas industry where several techniques have been developed to alleviate these bottlenecks. To speed up computations, oil and gas industries use parallel computing techniques. To alleviate the memory bottleneck, algorithms have been developed to reduce the size of necessary memory. These algorithms, however, reduce the size of memory by requiring an additional numerical simulation backward in time to reconstruct the source wavefields. These solutions are effective in the oil and gas industry, but are costly for nondestructive testing in concrete applications. Imaging a concrete member of considerable size with RTM can take days. Considering the nature of problems in NDT of concrete members, more affordable solutions must be developed.

### SUMMARY OF THE DISCLOSURE

The present disclosure addresses the aforementioned drawbacks by providing a method for producing an image of an object, which includes scanning the object with an ultrasound transducer comprising a plurality of transducer elements in order to obtain ultrasound data; forming an image matrix corresponding to a region in the object from which ultrasound data were acquired; and reconstructing an image from the ultrasound data by applying an analytical reverse time migration algorithm to each pixel in the image matrix, thereby assigning a pixel value to each pixel in the image matrix.

The foregoing and other aspects and advantages of the present disclosure will appear from the following description. In the description, reference is made to the accompanying drawings that form a part hereof, and in which there is shown by way of illustration a preferred embodiment. This embodiment does not necessarily represent the full scope of the invention, however, and reference is therefore made to the claims and herein for interpreting the scope of the invention.

### BRIEF DESCRIPTION OF THE DRAWINGS

FIGS. 1A-1C illustrate the location of the fictitious (i.e., virtual) sources corresponding a real source to consider reflections from horizontal bottom and top boundaries (FIG. 1A), an inclined bottom boundary (FIG. 1B), and a lateral boundary (FIG. 1C).

FIGS. 2A and 2B depict an example of a source signal (FIG. 2A) and propagation of a source wavelet in a homogeneous medium (FIG. 2B).

FIG. 3 illustrates a schematic representation of an implementation of an analytical RTM algorithm according to some embodiments described in the present disclosure.

FIGS. 4A-4E show examples of cross-correlation of downgoing source and upgoing receiver wavefields illuminating the top boundary (FIG. 4A), cross-correlation of downgoing source and downgoing receiver as well as upgoing source and upgoing receiver wavefields illuminating the boundaries with a steep slope (FIGS. 4B and 4C), and cross-correlation of upgoing source and downgoing receiver wavefields illuminating the bottom boundary (FIGS. 4D and 4E) of example embedded objects.

FIG. 5 shows an example where a backwall reflected signal can be interpreted as a reflection from a reflector in the medium.

FIG. 6 shows an example of a source-normalized imaging condition that assigns different values to points A and B.

FIG. 7 shows an example of the distance of real and fictitious sources and receivers from an imaging point.

FIG. 8 shows the geometry and boundary conditions of the foundation and location of the virtual device used in the example study described in the present disclosure.

FIG. 9 shows an example of a linear array device (MIRA) having a 4×10 array of dry point contact transducers that emit low frequency shear waves.

FIGS. 10A-10D show reconstructed images with 1 mm×1 mm pixels of first trial of the analytical approach (FIG. 10A) 2 mm×2 mm pixels of first trial of the analytical approach (FIG. 10B) and 4 mm×4 mm pixels of first trial of the analytical approach (FIG. 10C), and the first trial of the conventional RTM (FIG. 10D).

FIGS. 11A-11D show reconstructed images with 1 mm×1 mm pixels of second trial of the analytical approach (FIG. 11A) 2 mm×2 mm pixels of second trial of the analytical approach (FIG. 11B) and 4 mm×4 mm pixels of second trial of the analytical approach (FIG. 11C), and the second trial of the conventional RTM (FIG. 11D).

FIG. 12 shows a reconstructed image of an example region-of-interest.

FIG. 13 is a block diagram of an example system for reconstructing images using an analytical RTM algorithm.

FIG. 14 is a block diagram of example hardware that can implement the system of FIG. 13.

### DETAILED DESCRIPTION

Described here are systems and methods for nondestructive testing using ultrasound transducers, such as dry point contact (“DPC”) transducers or other transducers that emit horizontal shear waves. An analytical reverse time migration (“RTM”) technique is implemented to generate images from data acquired using the ultrasound transducers.

The present disclosure describes an analytical RTM technique that is capable of eliminating computational and memory bottlenecks of previous RTM techniques. Using the analytical RTM technique described in the present disclosure, an operator can quickly obtain an image of the scanned medium using a computer system, which may include a laptop or an ordinary computer. This image can be obtained by applying the analytical RTM to data acquired by DPC, or other, transducers transmitting horizontal shear waves (e.g., shear transducers).

As described in more detail below, the analytical RTM technique includes an assumption that the condition of anti-plane shear deformations in the scanned medium holds. Using this assumption, an analytical approach in which a closed-form term is obtained for the time history of the motion of one particle of the medium can be obtained. Only one displacement component is nonzero in anti-plane shear. Then, the time history of motion of that one particle can be used to obtain the time history of the motion of other particles in the medium.

The analytical RTM technique described in the present disclosure is capable of reconstructing images with lower resolution with a very low computation cost. Those images can be used for geometry measurement or localization and characterization of inclusions and defects with high accuracy.

Moreover, the analytical RTM approach described in the present disclosure enables imaging each point independently because the time history of motion of any point is dependent on the time history of the motion of only one particle. This capability of the can further reduce the computation cost by allowing for the restriction of imaging to a region-of-interest (ROI) where the probability of defects or inclusions is higher. A low-resolution image reconstructed by the analytical RTM described in the present disclosure can be used to specify the ROI.

The methods described in the present disclosure can be used for crack detection in sensitive structures, such as nuclear power plants and concrete liquid storage tanks. Detecting bottom-up cracks in concrete pavements is another application. Another example application is geometry measurement of structures that are only accessible from one side, such as the foundation of bridges and buildings

Before describing the analytical RTM technique, the conventional RTM algorithm is first described. Then, the proposed analytical approach is presented and its benefits are discussed.

RTM is an imaging method that processes data collected by an acquisition system that includes actuators and sensors to reconstruct an image of the scanned medium. The RTM algorithm takes the average density, velocity of the wave, and the source wavelet as inputs and performs the following steps to reconstruct an image of the scanned medium.

First, a numerical simulation is setup using a homogeneous elastic medium that has an average density and an average velocity of the scanned medium, which is excited by a sender located at the position of the actuator that emits the source wavelet. This simulation is used to reconstruct the entire time history of the wavefield of the actuator (S(x,t)), where x represent the coordinates of a point in the medium and t denotes time.

Then, in another numerical simulation, the homogeneous elastic medium is excited by senders placed at the location of the sensors. The received signals by the sensors are reversed in time. Then, the senders transmit the time-reversed signals to the homogeneous medium to reconstruct the receiver wavefileds (R(x,T−t)), where T is total time of data collection. Because the signals are reversed in time, the obtained wavefields are at time T—t.

Next, cross-correlation is used as an imaging condition to reconstruct the image of the scanned medium,

I(x)=∫₀^{T}S(x,t)R(x,t)dt (1).

In practice, the integral in Eqn. (1) is estimated numerically,

I(x)≅Σₘ₌₁ⁿS(x,mΔt)R(x,mΔt) (2);

where T=nΔt.

For multiple actuators, steps 1 and 2 would be repeated for each actuator, and then the corresponding reconstructed images would be stacked to obtain the final image,

I(x)≅Σₖ₌₁ⁿ^{ₐ}Σₘ₌₁ⁿSₖ(x,mΔt)Rₖ(x,mΔt) (3);

where nₐ is the total number of actuators.

It should be noted that most of the concrete members tested have a bottom boundary or backwall and are usually accessible from only one side. For these members, two trials may be needed for locating inclusions or defects. In the first trial, the RTM algorithm is applied to a half-space medium to locate the backwall of the member; this trial cannot locate the vertical parts of the backwall. In the second trial, RTM is applied to the medium with a backwall to locate inclusions or defects.

The reason for the high memory demand of RTM is that the cross-correlation (Eqn. (1)) needs source and receiver wavefields at the same time; nonetheless, the source wavefield, S(x,t), is propagated from time zero up to maximum time, and the receiver wavefield, R (x,T−t), is propagated in the reversed time direction from maximum time down to zero. Therefore, one of the wavefields is saved in memory. Because a very fine temporal and spatial grid is often used to avoid instability and grid dispersion, memory demand is high.

The reason for the high computation cost of RTM is that two numerical simulations are run for each actuator; therefore, for a large number of actuators, numerous simulations are required for imaging.

In accordance with the methods described in the present disclosure, an analytical approach is implemented to overcome the bottlenecks of the RTM technique when data are acquired using DPC transducers that emit ultrasonic horizontal shear waves (e.g., shear transducer). For this type of transducer, it can be assumed that the anti-plane shear deformation condition in the excited medium holds (e.g., one displacement component is nonzero in anti-plane shear). In the methods described in the present disclosure, the time history of motion of one particle of the medium is obtained. Then, the asymptotic behavior of anti-plane shear in far field is used to obtain the time history of motion of the other particles of the medium from the time history of motion of that one particle. Because the time history of motion of only one particle is needed to obtain the entire history of the wavefield, the memory bottleneck of previous RTM implementations is eliminated. Using the analytical RTM approach described in the present disclosure also leads to a significant decrease in computation cost by avoiding multiple numerical simulations and the constraint to use a fine temporal and spatial grid.

To develop the analytical approach, the wave equation corresponding to anit-plane shear can first be derived. Starting with the equation of motion:

$$ρ {\ddot{u}}_{i} = \frac{\partial {σ}_{ij}}{\partial {x}_{j}} + {f}_{i} ; \qquad ( 4 )$$

where ρ is the density of the material; uᵢ is the displacement component oriented in the xᵢ-direction; σᵢⱼ is the stress tensor component (σᵢⱼ=σⱼᵢ); and ƒᵢ is the body force, which in some implementations can be assumed to be zero.

The constitutive equation for linear isotropic behavior and small deformations is as follows:

σᵢⱼ=λδᵢⱼϵₖₖ+2μϵᵢⱼ (5);

where λ and μ are Lamé constants; δᵢⱼ is Kronecker delta (one for i=j, and zero otherwise); ϵᵢⱼ is the strain tensor component (ϵᵢⱼ=ϵⱼᵢ) given by,

$${ϵ}_{ij} = \frac{1}{2} ( \frac{\partial {u}_{i}}{\partial {x}_{j}} + \frac{\partial {u}_{j}}{\partial {x}_{i}} ) . \qquad ( 6 )$$

To derive the wave equation for anti-plane shear, it can be assumed that the waves propagate in the x-z plane and the particles are polarized in the y-direction. Since the only nonzero displacement component is u_{y}, the equation of motion can be simplified to,

$$ρ {\ddot{u}}_{y} = \frac{\partial {σ}_{xy}}{\partial x} + \frac{\partial {σ}_{zy}}{\partial z} ; \qquad ( 7 )$$

and the constitutive equations become:

$$\begin{matrix}{σ}_{xy} = μ \frac{\partial {u}_{y}}{\partial x} ; & ( 8 ) \\ {σ}_{yz} = μ \frac{\partial {u}_{y}}{\partial z} . & ( 9 )\end{matrix}$$

Combining Eqns. (7)-(9) results in the wave equation for horizontal shear waves:

$$\frac{{\partial }^{2} {u}_{y}}{\partial {x}^{2}} + \frac{{\partial }^{2} {u}_{y}}{\partial {z}^{2}} = \frac{1}{{c}_{s}^{2}} \frac{{\partial }^{2} {u}_{y}}{\partial {t}^{2}} ; \qquad ( 10 )$$

where cₛ is \sqrt{μ/ρ} and represents the velocity of the shear wave in the medium. Next, the time history of motion of a point at distance R from a DPC shear transducer is derived. Because the contact area of a DPC transducer with the scanned medium is relatively small, it can be assumed that the size of sender is also relatively small. It can also be assumed that the sender is located at the free surface of a half-space elastic homogeneous medium. The sender transmits a stress signal to a half-space medium,

σ_{zy}(x,0,z,t)=σₒƒ(t) (11).

The value of ƒ(0) in Eqn. (11) is zero. The stress is applied to a narrow area of width a.

To solve the wave equation with the prescribed stress, the partial differential equation (Eqn. (10)) can be converted to an ordinary differential equation by taking the Laplace transform with respect to time, and the Fourier transform with respect to x. Taking inverse Fourier and inverse Laplace transforms from the solution of the ordinary differential equation, the displacement at distance R from the emitter is obtained,

$${u}_{y} ( R , t ) = \{ \begin{matrix}0 & t \leq \frac{R}{{c}_{s}} \\ - \frac{{ασ}_{o} a}{μ} {\int }_{\frac{R}{{c}_{s}}}^{t} \frac{f ( t - τ )}{\sqrt{{τ}^{2} - {( \frac{R}{{c}_{s}} )}^{2}}} d τ , & t > \frac{R}{{c}_{s}}\end{matrix} ; \qquad ( 12 )$$

where α is a constant. In the implementations described in the present disclosure, the velocity field (rather than displacement field) is used for image reconstructions using RTM. The velocity is obtained by taking the time derivative of displacement,

$${v}_{y} ( R , t ) = \{ \begin{matrix}0 & t \leq \frac{R}{{c}_{s}} \\ - \frac{{ασ}_{o} a}{μ} {\int }_{\frac{R}{{c}_{s}}}^{t} \frac{\frac{df ( t - τ )}{dt}}{\sqrt{{τ}^{2} - {( \frac{R}{{c}_{s}} )}^{2}}} d τ & t > \frac{R}{{c}_{s}}\end{matrix} . \qquad ( 13 )$$

It is worth noting that R/cₛ is the time of flight or time of travel of wave to a particle at distance R from the sender. At any time less than travel time to a particle, the particle is at rest. For each sender, the integral in Eqn. (13) is evaluated for all points of the medium to obtain the associated time history of the source or receiver wavefields. This procedure can be a computationally intensive task. In addition, a massive memory may be needed to save the source or the receiver wavefields. To overcome these challenges, the asymptotic behavior of horizontal shear waves for point sources can be utilized to reduce computational cost and memory requirements. Based on the asymptotic behavior, the amplitude of a signal at far field distances R₁ and R₂ from the source are related by the following:

$${v}_{y} ( {R}_{2} , t + \frac{{R}_{2}}{{c}_{s}} ) = \sqrt{\frac{{R}_{1}}{{R}_{2}}} {v}_{y} ( {R}_{1} , t + \frac{{R}_{1}}{{c}_{s}} ) . \qquad ( 14 )$$

Eqn. (14) is advantageous for removing the bottlenecks of RTM and making it applicable to nondestructive testing. If the response of only one point in the medium far enough from the sender is measured or otherwise known, Eqn. (14) allows for the determination of the response of all other points for which the asymptotic behavior holds. For a sender of size 1 mm, to use the asymptotic behavior R can be 50 mm or larger.

In general, a low frequency signal is not advantageous for localization or characterization in near field. Therefore, Eqn. (14) can be applied to all points of a medium without losing any beneficial information. If multiple senders are transmitting signals to a medium simultaneously, wavefields of each sender can be obtained. Then, the linearity of the wave equation can be advantageously utilized to obtain the wavefields of multiple senders by superimposing the wavefields of each sender.

As mentioned above, the first trial of RTM can be applied to a half-space medium to locate the bottom boundary, which can then be used as the input of the second trial simulations. Because in these instances the analytical RTM solution is derived for a half-space medium, a technique to consider reflections from the bottom boundary can be implemented. As one example, a technique can be implemented in which fictitious, or virtual, sources are used to consider reflections. Each fictitious source corresponds to a real source and to one reflection from the top or the bottom boundary, and each fictitious source emits the same signal as the corresponding real source.

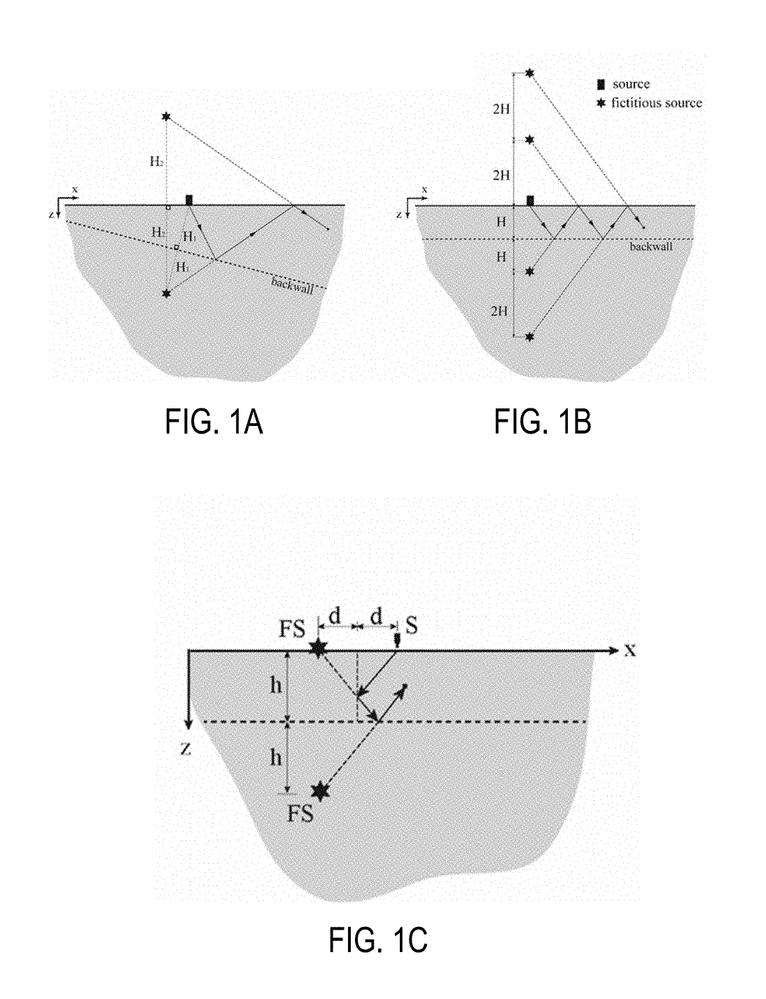

A fictitious source is generally located such that the time-of-flight of a signal transmitted from the real and the fictitious sources to any point inside the medium is the same, as shown in FIG. 1A. That is, at any time, both real and fictitious sources can result in the same response at any point inside the medium. To satisfy this condition, the fictitious source corresponding to the first reflection from a bottom boundary should be the mirror image of the real source with respect to that boundary, as shown in FIGS. 1A and 1B. In using this technique, if the medium is resting on another medium with a lower acoustic impedance, it can be assumed that its bottom boundary is free. Otherwise, it can be assumed that its bottom boundary is fixed. For a free boundary, the source signal sent by the fictitious source remains unchanged. For a fixed boundary, the source signal would be multiplied by negative one to take into account the change in phase of a wave when it reflects from the fixed boundary.

To consider reflection from a lateral boundary, a fictitious source which is the mirror image of the real source with respect to the lateral boundary should be introduced, as shown in FIG. 1C. To consider reflections from bottom boundary, after reflections from the lateral boundary, the mirror image of the fictitious source with respect to the bottom boundary is obtained, as shown in FIG. 1C.

The analytical RTM approach described in the present disclosure offers several advantages over previous numerical implementations of RTM. For one, the memory bottleneck is significantly reduced because the time history of motion of just one particle can be used to obtain the entire time history of the wavefield. As another advantage, the computational burden is significantly decreased relative to the numerical RTM approaches because the response is just for one particle of a medium (Eqn. (13)). The responses of other points are calculated by multiplying the response of that one particle by a modification factor (Eqn. (14)). The wave equation is not discretized temporally or spatially, so larger pixels and time steps can be used to reconstruct the image of the scanned medium.

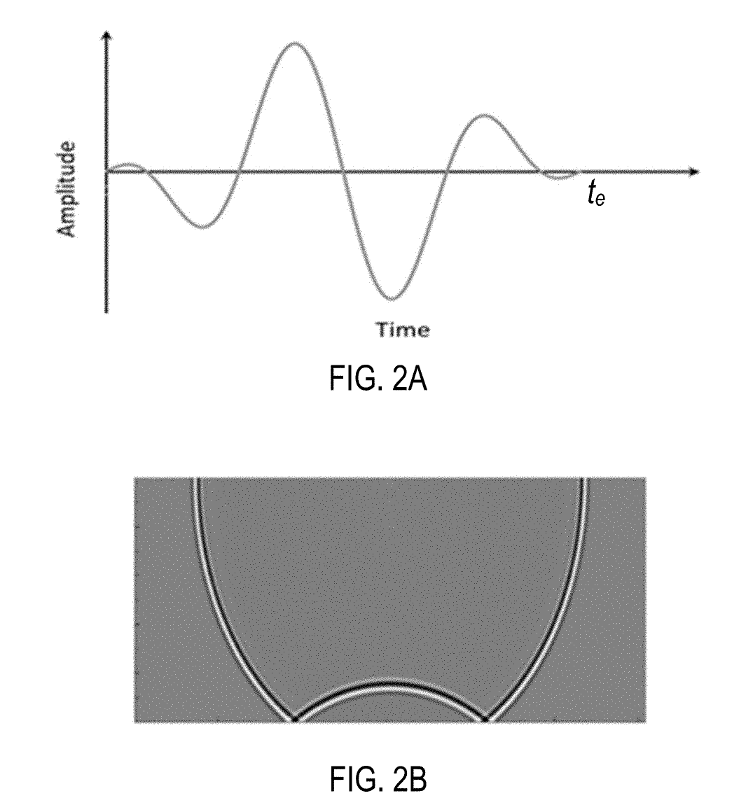

Another advantage of the analytical RTM approach described in the present disclosure is that the integration in Eqn. (1) can be performed in a shorter time than it takes to acquire the entire data set. For example, considering only one reflect from the bottom boundary, no reflection from the top boundary, and if the time length of the source wavelet is tₑ, then for particles far from the bottom boundary where the incident and reflected waves do not interact, the total time of the nonzero response is 2tₑ, as illustrated in FIGS. 2A and 2B. For particles close to the boundary, where the incident and reflected waves interfere, this value is less than 2tₑ. Therefore, the value of S(x,t) in Eqn. (1) is zero for a duration of at least T−2tₑ. Furthermore, the proposed analytical approach enables imaging any point independently. The reason for this advantage is that the time history of motion of any point can be determined individually and can be imaged by Eqn. (2). Imaging individual points is beneficial when imaging an ROI rather than the entire scanned medium. The ROI can be determined from a low-resolution image reconstructed by the analytical approach, or otherwise. The analytical approach can take advantage of individual point imaging for a further reduction of computation burden.

In the analytical RTM approach, the response at distance R from each source transmitting the source signal and the time-reversed signals is first obtained. The responses at distance R far enough from the sources are saved in memory and are used to obtain the response at the other points in the medium. To simplify this procedure, v_{y}(R,t+R/cₛ) can be saved or the zero responses corresponding to the travel time duration can be eliminated, and Eqn. (14) can be used.

To obtain the response at a distance R from the sender, the integral in Eqn. (13) can be evaluated. One example for doing this includes approximating a function, ƒ(t), using linear B-splines,

$$f ( t ) = {\sum }_{i} {N}_{i} {f}_{i} ; \qquad ( 15 )$$

where Nᵢ(t) is a triangular function that is one if t=iΔt and zero if t is less than (i−1)Δt and greater than (i+1)Δt. With the linear approximation of function ƒ(t), df(t)/dt becomes constant and the integral in Eqn. (13) can be evaluated analytically.

In some examples, it can be assumed that the sources emit a velocity signal and the receivers record the velocity of the in-contact particles. To derive the analytical solution, it can be assumed that the source emits a stress signal (Eqn. (11)). Therefore, in such examples, the velocity signal can be obtained from the stress signal. As one example of doing this, the fact that for a very small R, the sent and received signals are virtually the same can be used. As a result, to obtain the stress signal a point very close to the source can be considered and the function ƒ(t) obtained from Eqn. (13). To do this, it can be assumed that the values of ƒᵢ in Eqn. (15) are unknown. To evaluate the unknowns, it can be first assumed that t=Δt and the value of ƒ₁ obtained using the value of velocity signal at time Δt. Knowing the value of ƒ₁, ƒ₂ is evaluated by assuming that t=2Δt. The same procedure is used to evaluate the rest of the unknowns.

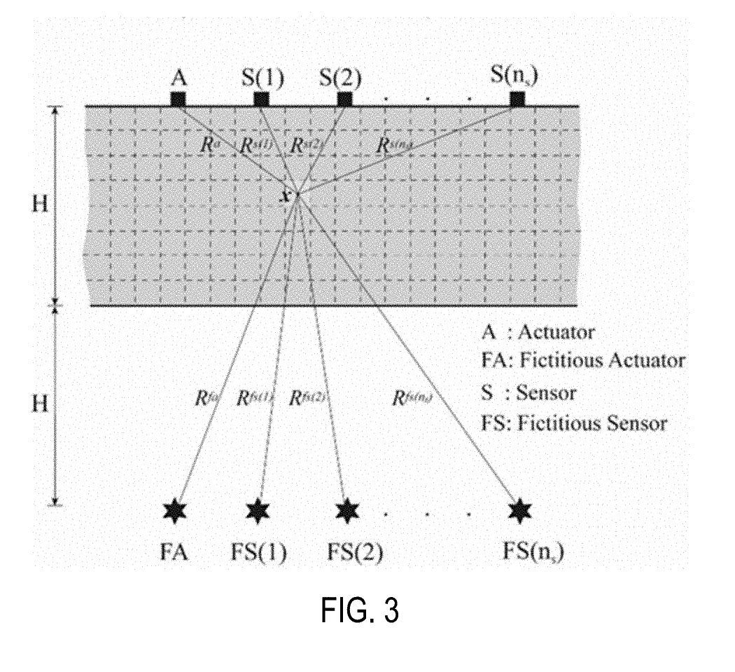

To reconstruct the image of the scanned medium, the medium is decomposed into pixels, such as rectangular pixels, as shown in FIG. 3, and the analytical RTM algorithm assigns a value to each pixel. For a pixel with center point located at x, the RTM algorithm described in the present disclosure is applied to each actuator and the corresponding sensors to obtain the value of I(x) (Eqn. (2)). To do this, the distances from the actuators (e.g., sources), the sensors (e.g., receivers), and the corresponding fictitious senders (e.g., fictitious sources) to the center point of the pixel are obtained, as illustrated in FIG. 3. If the location of the bottom boundary is unknown, the fictitious sources can be overlooked in imaging and the bottom boundary can be located by applying an RTM algorithm to a half-space medium, for example. These distances are used to obtain the travel time of the waves to x. The travel time from the place of the actuator is denoted by t_{ƒ}^{a} and the sensors by t_{ƒ}^{s}. Travel time of a sender corresponding to the fictitious actuator is denoted by tₐ^{af} and of the fictitious sensor is denoted by t_{ƒ}^{sf}. Then, these distances are used to obtain the response of the medium at x to the source and time-reversed signals sent from the location of the actuator and the sensors. In these examples, the response at x and at time t is the velocity of the vibrating point located x at time t (v_{y}(x,t)).

To obtain the cross-correlation at x, the response of the medium to the source signal at this point is first determined. The response at x and at time t to the incident wave originated from the location of actuator is nonzero if t_{ƒ}^{a}<t<t_{ƒ}^{a}+tₑ. For the fictitious source, this condition is t_{ƒ}^{fa}<t<t_{ƒ}^{fa}+tₑ The response to the source signal is as follows:

S(x,t)=v_{y}^{a}(x,t)+v_{y}^{fa}(x,t) (16);

where v_{y}^{a}(x,t) is the response to the source and v_{y}^{fa}(x,t) is the response to the corresponding fictitious source. If the value of S(x,t) is zero, the computations for obtaining the response to the sources emitting the time-reversed signals can be skipped and the next time step selected.

Next, the response to senders emitting the time-reversed signals at the location of the sensors is determined. For these senders, the response at time t is R(x,T−t). While, the cross-correlations use the response at time t. To find the time t in the algorithm T—t can be subtracted from T. Now, a loop over senders corresponding to sensors to obtain the value of R(x,t) can be performed. For sensor number i, if t≥t_{ƒ}^{s(i)} the response is nonzero, t_{ƒ}^{s(i)} is the travel time from sender number i to x. The same procedure can be repeated for the corresponding fictitious sender. The response to sender number i considering reflection is,

Rᵢ(x,t)=v_{y}^{s(i)}(x,t)+v_{y}^{fs(i)}(x,t) (17);

here v_{y}^{s(i)}(x,t) is the response to the sender and v_{y}^{s(i)}(x,t) is the response to the corresponding fictitious sender. The same procedure can be repeated for the other sensors to obtain the response at x to the senders at the location of the sensors and emit the time reversed signals,

R(x,t)=Σᵢ₌₁ⁿ^{ₛ}Rᵢ(x,t) (18);

nₛ in Eqn. (17) is the total number of sensors. By looping over all time steps, the value of I(x) is determined (Eqn. (2)).

By looping over all pixels, the image of the scanned medium is reconstructed. For multiple actuators, the reconstructed images of each actuator and the corresponding sensors are stacked to obtain the final reconstructed image (Eqn. (3)).

Decomposition of the source and receiver wavefields to upgoing and downgoing can provide additional insights into the mechanism of image reconstruction using RTM,

S(x,t)=S_{d}(x,t)+Sᵤ(x,t) (19);

R(x,t)=R_{d}(x,t)+Rᵤ(x,t) (20);

where S_{d} and R_{d} are the downgoing source and receiver wavefields, respectively, and Sᵤ and Rᵤ are the upgoing source and receiver wavefields, respectively. S_{d} and Rᵤ are emitted by real sources and Sᵤ and R_{d} are emitted by fictitious sources in the analytical RTM approach. Note that if the source and receiver wavefields are extrapolated using numerical simulations, the decomposition can be mostly performed by applying Fourier transform to the source and receiver wavefields. The analytical RTM technique provides the upgoing and downgoing wavefields by introducing fictitious sources at no additional computation cost. By substituting Eqns. (19) and (20) into Eqn. (1), the imaging condition can be written in terms of upgoing and downgoing source and receiver wavefields,

I(x)=∫₀^{T}S_{d}(x,t)R_{d}(x,t)dt+∫₀^{T}S_{d}(x,t)Rᵤ(x,t)dt+∫₀^{T}Sᵤ(x,t)R_{d}(x,t)dt+∫₀^{T}Sᵤ(x,t)Rᵤ(x,t)dt. (21).

The first, second, third, and the fourth terms in the right-hand side of Eqn. (21) can be denoted as by I_{dd}, I_{du}, I_{ud} and Iᵤᵤ, respectively. Therefore, Eqn. (21) can be written as,

I(x)=I_{dd}(x)+I_{du}(x)+I_{ud}(x)+Iᵤᵤ(x). (22).

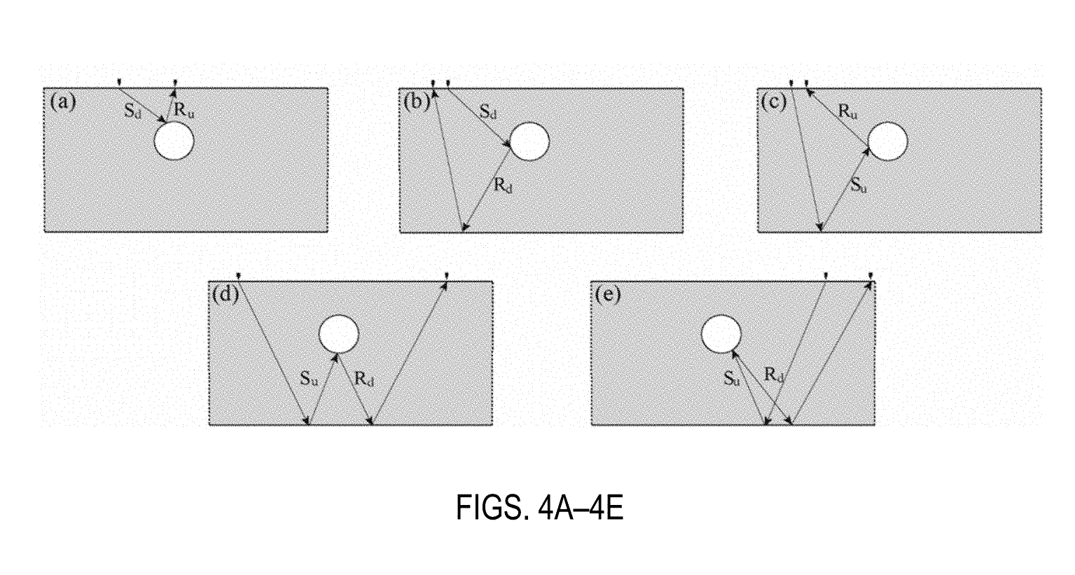

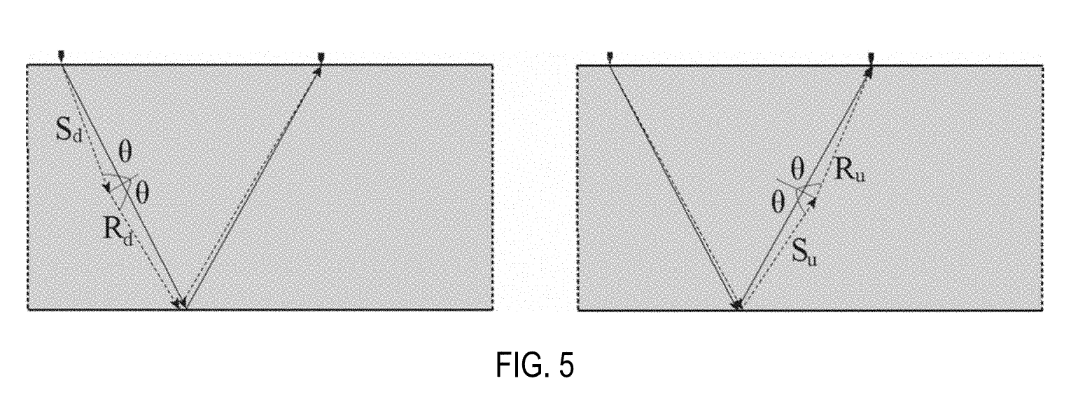

The role of each of the four terms in the imaging condition in Eqn. (22) in image reconstruction can be explained by considering reflections from a cavity located in an isotropic homogeneous medium (FIGS. 4A-4D).

FIG. 4A shows that the I_{du} term illuminates the top boundary of the embedded object. FIGS. 4B and 4C indicate that the I_{dd} and Iᵤᵤ terms illuminate the lateral boundaries of the embedded object where the reflector's boundary has a steep slope. Based on FIGS. 4D and 4E, the I_{ud} term illuminates the bottom boundary of the embedded object. Note that if the reflector does not have a bottom boundary, then including the I_{ud} term in Eqn. (22) may introduce false images and artifacts into the reconstructed images. The decomposed wavefields can be used to identify and eliminate the source of artifacts and adjust the amplitude in the reconstructed images of RTM.

The backwall reflected signals can be a source of noise in a reconstructed image. As can be seen from FIG. 5, nonzero time length of the source wavelet (FIG. 2A) gives rise to interpretation of the backwall reflected signal as a reflection from a reflector in the medium.

One approach to eliminate these noises from the reconstructed images is to replace the data associated with the reflection from the bottom boundary of the medium with zeros when obtaining the I_{dd}, Iᵤᵤ terms of the imaging condition. This method is straightforward and does not impose any significant computation cost. Another approach is to define a weight function and apply it to the I_{dd} and Iᵤᵤ terms of the imaging condition to suppress the artifacts in the reconstructed images,

I(x)=ΣₛΣᵣ(w(θ_{dd})∫₀^{T}S_{d}(x,t)R_{d}(x,t)dt+∫₀^{T}S_{d}(x,t)Rᵤ(x,t)dt+∫₀^{T}Sᵤ(x,t)R_{d}(x,t)dt+w(θᵤᵤ)∫₀^{T}Sᵤ(x,t)Rᵤ(x,t)dt). (23).

The weight function can be 0 for θ=π/2, and its value can be increased gradually to 1.0 at a threshold angle, θₜ. The value of the threshold angle θₜ is a function of the time length of the source wavelet. The threshold angle can therefore be increased as the time length of the source wavelet is increased. One example of a weight function is, therefore,

$$w ( θ ) = \{ \begin{matrix}1 & θ < {θ}_{t} \\ {( \frac{π / 2 - θ}{π / 2 - {θ}_{t}} )}^{2} & {θ}_{t} \leq θ \leq π / 2\end{matrix} , \qquad ( 24 ) .$$

Note that in most instances the value chosen for θₜ should be as small as possible to prevent losing beneficial information in the recorded data.

Cross-correlation of the source and receiver wavefields may not represent the reflectivity of a reflector correctly in all instances. To show this, assume an example where the same reflector is located at different depths of a medium. In this instance, S(x,t) and R(x,t) have smaller value for a reflector at a deeper depth; therefore, their cross correlation leads to smaller image intensities due to geometrical spreading attenuation. Generally, attenuation influences the amplitude in a reconstructed image. In the following, approaches are described for obtaining images with a more accurate amplitude.

Normalization is generally used to correct the amplitude in the reconstructed images. To do this, source/receiver-normalized imaging conditions, such as the following, can be used:

$$\begin{matrix}I ( x ) = \frac{{\int }_{0}^{T} S ( x , t ) R ( x , t ) dt}{{\int }_{0}^{T} {R}^{2} ( x , t ) dt} , & ( 25 ) ; \\ I ( x ) = \frac{{\int }_{0}^{T} S ( x , t ) R ( x , t ) dt}{{\int }_{0}^{T} {S}^{2} ( x , t ) dt} . & ( 26 ) .\end{matrix}$$

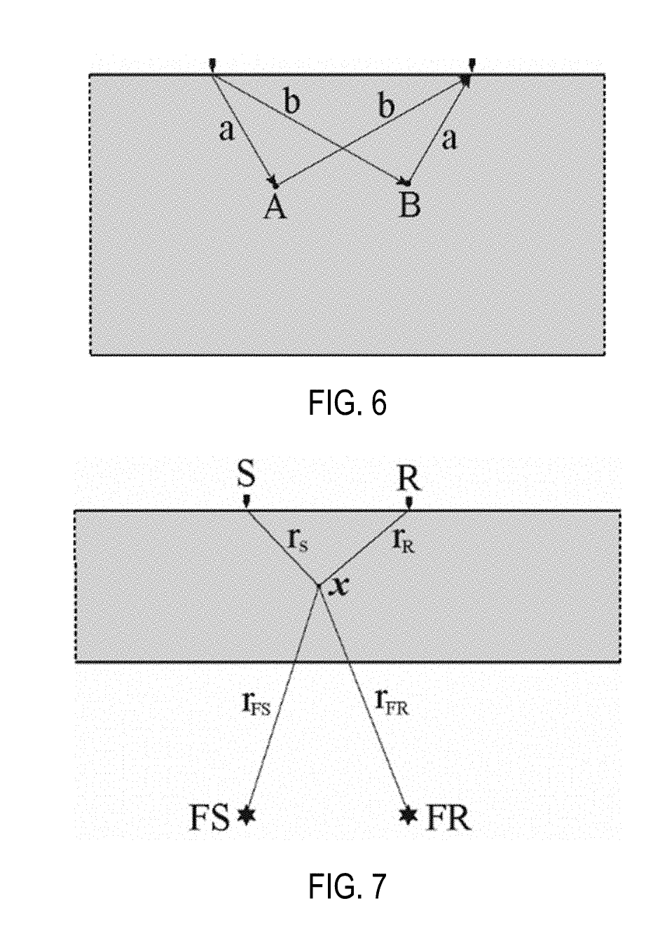

Normalization may take into account geometrical spreading attenuation. However, the receiver-normalized imaging condition in Eqn. (25) may lead to an incorrect reflectivity strength. To show this, assume a reflector in a medium. If the material of the reflector is changed to one with different acoustic properties, the amplitude of the signal measured after reflection from the one with higher acoustic impedance contrast with the background medium will be larger. In this case, the receiver-normalized imaging condition leads to a smaller image intensity in the reconstructed image. This normalization approach also assigns larger image intensity to the same reflector located in a deeper depth. While, the source-normalized imaging condition in Eqn. (26) does not impose the aforementioned limitations, it may in some instances misrepresent the geometrical spreading attenuation of received signals. This can be shown by considering points A and B in FIG. 6, for which the cross-correlation of source and receiver wavefields leads to the same value.

The value of ∫₀^{t}S²(x,t)dt is different for points A and B (a≠b) and the source-normalized imaging condition leads to two different values in these points. Note that the time of flight from the source to these points and from these points to the receiver is the same. To resolve this limitation, a new normalization factor can be defined. This normalization factor considers geometrical spreading attenuation of both source and receiver signals. To this end, the source wavelet can be transmitted from the location of the source and the receivers to define the new normalization factor,

NF=\sqrt{∫₀^{T}S_{S}²(x,t)dt}\sqrt{∫₀^{T}S_{R}²(x,t)dt} (27).

∫₀^{T}S_{S}²/(x,t)dt and ∫₀^{T}S_{R}²(x,t)dt are obtained by transmitting the source wavelet from the location of the source and the receiver, respectively. It should be noted that although obtaining wavefields associated with sending the source signal from the location of the receivers enforces extra computational cost in the numerical simulations, it can be evaluated with no additional cost by using the analytical approach described in the present disclosure. Using the new normalization factor, the following new imaging condition is obtained:

$$I ( x ) = {\sum }_{s} {\sum }_{r} ( \frac{{\int }_{0}^{T} {S}_{d} ( x , t ) {R}_{d} ( x , t ) dt}{\sqrt{{\int }_{0}^{T} {S}_{S}^{2} ( x , t ) dt} \sqrt{{\int }_{0}^{T} {S}_{R}^{2} ( x , t ) dt}} + \frac{{\int }_{0}^{T} {S}_{d} ( x , t ) {R}_{u} ( x , t ) dt}{\sqrt{{\int }_{0}^{T} {S}_{S}^{2} ( x , t ) dt} \sqrt{{\int }_{0}^{T} {S}_{FR}^{2} ( x , t ) dt}} + \frac{{\int }_{0}^{T} {S}_{u} ( x , t ) {R}_{d} ( x , t ) dt}{\sqrt{{\int }_{0}^{T} {S}_{FS}^{2} ( x , t ) dt} \sqrt{{\int }_{0}^{T} {S}_{R}^{2} ( x , t ) dt}} + \frac{{\int }_{0}^{T} {S}_{u} ( x , t ) {R}_{u} ( x , t ) dt}{\sqrt{{\int }_{0}^{T} {S}_{FS}^{2} ( x , t ) dt} \sqrt{{\int }_{0}^{T} {S}_{FR}^{2} ( x , t ) dt}} ) . \qquad ( 28 ) .$$

The summations in Eqn. (28) go over the sources and the corresponding receivers. Here, we show that the using of the analytical approach leads to a simple term for the normalization factor that helps understanding its role in the imaging condition. If the point at x is located at a distance r′ from the source or receiver, the normalization factor in terms of the response at a fixed distance, r, from the source or receiver is,

$${\int }_{0}^{T} {S}^{2} ( {r}^{′} , t ) dt = {\int }_{0}^{T} {( \frac{\sqrt{r}}{\sqrt{{r}^{′}}} s ( r , t ) )}^{2} dt = \frac{r}{{r}^{′}} {\int }_{0}^{T} {s}^{2} ( r , t ) dt = \frac{cr}{{r}^{′}} . \qquad ( 29 ) .$$

Note that the value of ∫₀^{R}s² (r,t)dt for a fixed r is constant and is denoted by c in Eqn. (29). Using Eqn. (29), the imaging condition in Eqn. (28) can be simplified to the following:

$$I ( x ) = \frac{1}{cr} ( {\sum }_{s} {\sum }_{r} ( \sqrt{{r}_{s} {r}_{FR}} {\int }_{0}^{T} {S}_{d} ( x , t ) {R}_{d} ( x , t ) dt + \sqrt{{r}_{s} {r}_{R}} {\int }_{0}^{T} {S}_{d} ( x , t ) {R}_{u} ( x , t ) dt + \sqrt{{r}_{FS} {r}_{FR}} {\int }_{0}^{T} {S}_{u} ( x , t ) {R}_{d} ( x , t ) dt + \sqrt{{r}_{FS} {r}_{R}} {\int }_{0}^{T} {S}_{u} ( x , t ) {R}_{u} ( x , t ) dt ) ) ) . \qquad ( 30 ) .$$

r_{S} and r_{FS} are the distance of the source and the fictitious source from the point at x, and r_{R} and r_{FR} are the distance of the receiver and the fictitious receiver from the point at x, respectively (FIG. 7). Note that the value of 1/cr is constant for all points of the medium and it does not affect the reconstructed image; therefore, it can be eliminated from Eqn. (30). Likewise, the source-normalized imaging condition can be simplified to,

I(x)=ΣₛΣᵣ(r_{S}∫₀^{R}S_{d}(x,t)R_{d}(x,t)dt+r_{S}∫₀^{T}S_{d}(x,t)Rᵤ(x,t)dt+r_{FS}∫₀^{T}Sᵤ(x,t)R_{d}(x,t)dt+r_{FS}∫₀^{T}Sᵤ(x,t)Rᵤ(x,t)dt)) (31).

Scattering by aggregates and air voids attenuates the energy of the transmitted waves into concrete members. The amount of attenuation is a function of the frequency content of the emitted signal, the size and the material properties of aggregates, and the size and volume of air voids. The attenuation can be defined using an attenuation coefficient that relates the amplitude of the emitted signal to the amplitude of the recorded signal after travelling of distance x in the medium, such as by,

$$α = - \frac{20}{x} {log}_{10} ( \frac{{A}_{x}}{{A}_{o}} ) . \qquad ( 32 ) .$$

Using Eqn. (32), the modification factor that is applied to the recorded signal to scattering attenuation can be obtained as,

$$\frac{{A}_{o}}{{A}_{x}} = {10}^{( \frac{ax}{20} )} . \qquad ( 33 ) .$$

Attenuation of the emitted signals by the aggregates and air voids in concrete results in assigning different image intensities to the boundaries of the same object located at different depths of a medium. Attenuation has a higher effect on Iᵤᵤ due to a large travelling distance of the emitted signal before measured by a receiver (FIGS. 4D and 4E). The amplitude of the received signals can be modified by the modification factor introduced in Eqn. (33) and the modified received signal can be used to obtain a new imaging condition. The new imaging condition with the new normalization factor and modification factor to consider scattering attenuation is given as,

$$I ( x ) = {\sum }_{s} {\sum }_{r} ( \sqrt{{r}_{S} {r}_{FR}} {10}^{( \frac{α ( {r}_{S} + {r}_{FR} )}{20} )} {\int }_{0}^{T} {S}_{d} ( x , t ) {R}_{d} ( x , t ) dt + \sqrt{{r}_{S} {r}_{R}} {10}^{( \frac{α ( {r}_{S} + {r}_{R} )}{20} )} {\int }_{0}^{T} {S}_{d} ( x , t ) {R}_{u} ( x , t ) dt + \sqrt{{r}_{FS} {r}_{FR}} {10}^{( \frac{α ( {r}_{FS} + {r}_{FR} )}{20} )} {\int }_{0}^{T} {S}_{u} ( x , t ) {R}_{d} ( x , t ) dt + \sqrt{{r}_{FS} {r}_{R}} {10}^{( \frac{α ( {r}_{FS} + {r}_{R} )}{20} )} {\int }_{0}^{T} {S}_{u} ( x , t ) {R}_{u} ( x , t ) dt ) . \qquad ( 34 ) .$$

The analytical RTM techniques described in the present disclosure can thus be used to decompose the source and receiver wavefields to upgoing and downgoing, and these can be used for improving the quality of the reconstructed images. In one example approach, backwall reflected signals are eliminated. In another example approach, a weight function is used. Both approaches can be used for the elimination of low-frequency high-amplitude artifacts. In addition, a new normalization factor is described for considering geometrical spreading attenuation. This new normalization factor can reduce the amplitude of artifacts and can assign more accurate amplitude to the points of a reconstructed image. Furthermore, by introducing a modification factor to the imaging condition to consider the scattering attenuation in the concrete members, the boundaries of a cavity in a concrete slab can be emboldened.

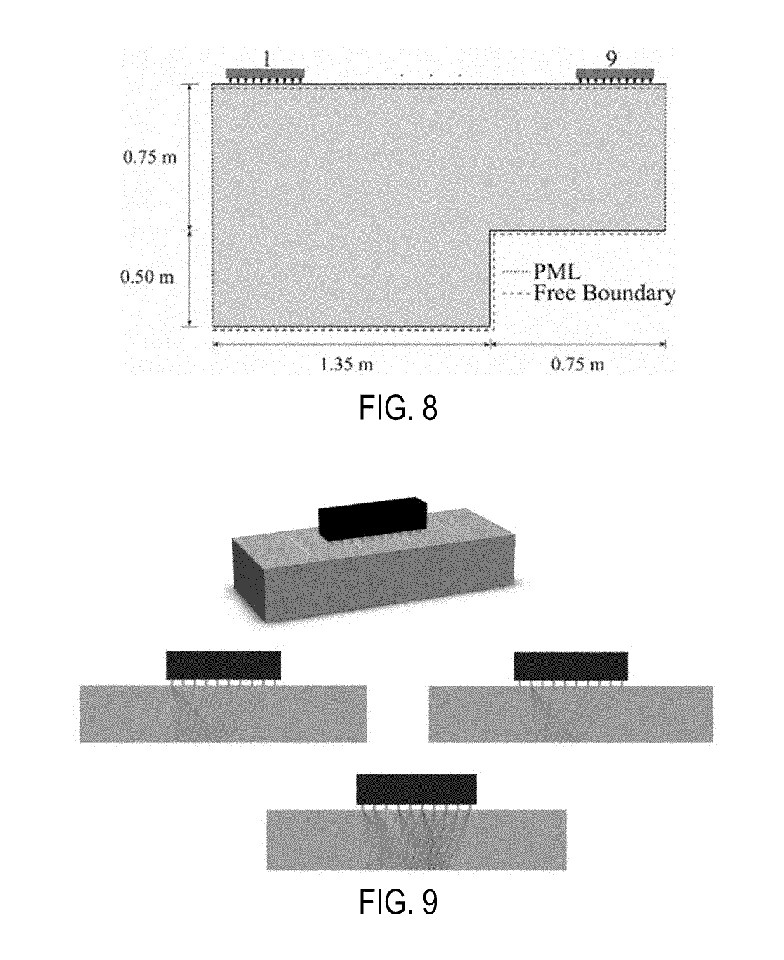

In an example study, the analytical RTM approach described in the present disclosure, and its performance, was compared with the conventional RTM in terms of accuracy and efficiency. The accuracy of the RTM analytical approach described in the present disclosure was investigated shown by imaging the bottom boundary of a homogeneous stepped foundation. The geometry of the foundation used in this example study is shown in FIG. 8. The material parameters of the homogeneous foundation are given in Table 1. The values of runtime and memory usage of the analytical RTM approach were compared with that of the conventional RTM next.

TABLE 1
Material and Simulation Parameters
Material parameters

| | |
|---|---|
| Density | ρ = 2400 kg/m³ |
| Shear velocity | cₛ = 2750 m/s |

Numerical simulations parameters

| | |
|---|---|
| Total time of simulation | T = 0.0015 s |
| Time step | Δt = 0.1 μs |
| Grid size | Δx = 0.001 m |

Previous studies have verified the ability of RTM to detect vertical boundaries of a real concrete foundation; this example study focused on using synthetic data. To generate these data, a program that is based on a second order accurate in time and space velocity-stress staggered-grid finite difference method was used. The program was written in FORTRAN and parallelized with OpenMP. A perfectly matched layers (“PML”) technique was implemented to truncate the numerical medium by absorbing outgoing waves to reduce the cost of computation. The thickness of the PML is ten grid spacing. The same program was used to perform numerical simulations of the conventional RTM. The parameters used in the numerical simulations for acquiring data and for reconstructing the source and receiver wavefields of conventional RTM are given in Table 1.

In the data acquisition process, the sensors were configured based on the nature of the problem. For example, if the goal is to detect the bottom boundary of a tendon duct, the sensors were spread on the top boundary of the member to measure the reflected signals from the bottom boundary of the tendon duct. For a stepped foundation, a linear array device can be an effective piece of equipment for locating the horizontal and vertical boundaries of the stepped foundation. It is worth noting that in the measurements where the device is located above the thinner part of the foundation, the device does not sense reflections from the vertical boundary; therefore, the measured data do not provide any information regarding the vertical boundary. The linear array device simulated in this example study is MIRA.

MIRA, version one, is a linear array device with a 4×10 array of DPC transducers emitting low frequency shear waves. An example of such a device is shown in FIG. 9. The distance between the adjacent rows of transducers of MIRA is 40 mm. The interaction between the channels of MIRA in each scan was such that the first channel of transducers act as actuators and the remaining nine channels act as sensors. Then, the second channels act as actuators and the remaining eight channels act as sensors. This pattern holds true for the rest of channels. As a result, 45 pairs of signals are provided in each scan. It was assumed that the senders emit the first derivative of the RC2 wavelet given by Eqn. (18),

h(t)=(1−cos(πƒₒt))cos(2πƒₒt), 0≤t≤2T₀ (35);

where ƒₒ is the center frequency of the wavelet, which is 50 kHz in this study, and Tₒ=1/ƒₒ. In sending and receiving with the simulated MIRA, it was assumed that the anti-plane shear deformation condition holds and each channel has one transducer.

In a real concrete foundation, the waves are attenuated due to the heterogeneity of concrete; therefore, using a sufficient number of scans may be utilized to enhance the image quality. For acquisition of synthetic data, nine overlapping scans were used in this example study. In the first scan, the horizontal distance between the first transducer of MIRA and the step was 1.25 m. After each scan, the virtual device was moved 0.20 m to the right for the next scan. The location of the virtual device in the first and the last scans are shown in FIG. 8.

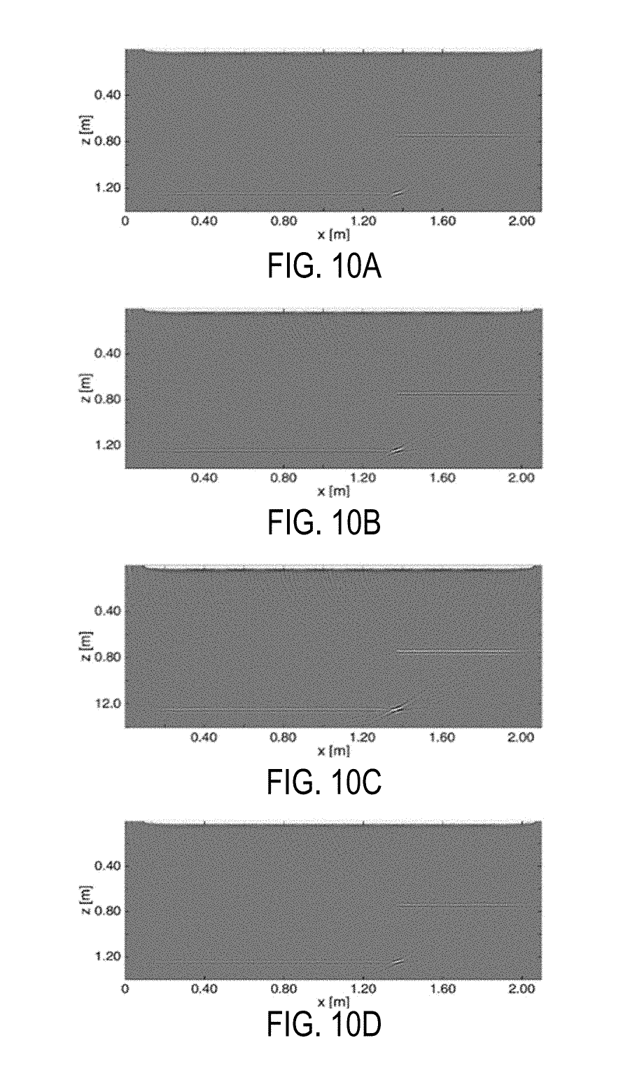

The imaging of the bottom boundary of a step foundation included two trials. In the first trial, the horizontal boundaries were located. Those were then used as input to locate the vertical boundary in the second trial. In the proposed analytical approach, it was assumed that Δt in Eqn. (2) is 1 μs. The imaging results for three different pixel sizes are shown in FIGS. 10A, 10B, and 10C. As can be seen, the horizontal boundaries are located accurately. It is worth noting that even with a large pixel size, an image with sufficient details to locate the horizontal boundaries can be obtained. The reason of this is the low frequency of the source signal.

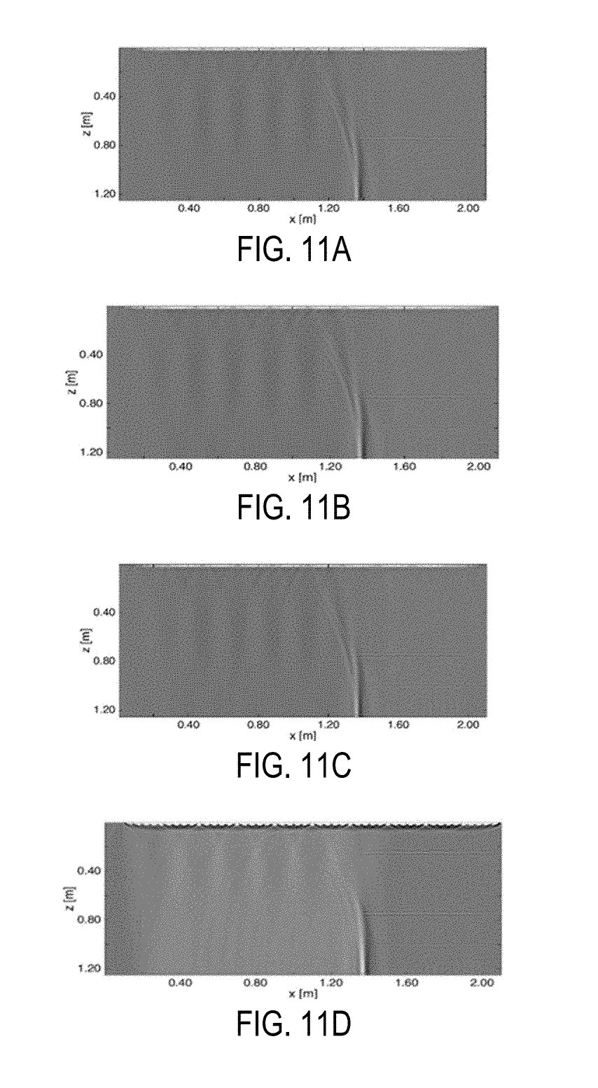

In the numerical simulations of the conventional RTM, the spacing of the spatial grid in the numerical simulations cannot be larger than 1 mm to avoid numerical dispersion; therefore, the pixel size of the corresponding reconstructed images are 1 mm×1 mm. The reconstructed image provided by the conventional RTM is provided in FIG. 10D. As expected, the conventional RTM located the horizontal boundaries accurately. In the second trial, the analytical and conventional RTM were applied to signals sent to a foundation with a uniform thickness of 1.25 m; reflections from the bottom boundary at the depth of 1.25 m locate the vertical boundary. The same numerical parameters used in the first trial of analytical and conventional RTM were used in the second trial. Only one reflection from the bottom boundary was considered in the analytical approach; therefore, fictitious senders were located under the bottom boundary at the depth of 2.50 m. The reconstructed images for the analytical and the conventional RTM are shown in FIGS. 11A, 11B, 11C, and 11D. Both analytical and conventional approaches located the vertical boundary correctly.

A reason for different types of high frequency artifacts in the analytical and conventional approaches can be a reflection from the perfectly matched layers. The thickness of these layers is ten grid spacing, which can lead to reflections from them. The analytical approach does not require using artificial boundaries to absorb outgoing waves.

The reason for horizontal artifacts at different depths in the thinner part of the foundation is using an incorrect velocity model by assuming a uniform thickness in the second trial. Reflections from a horizontal boundary located in an incorrect place will focus the source and receiver signals in an incorrect location. By placing the fictitious sources in the right location in another trial, these artifacts could be removed in the analytical RTM.

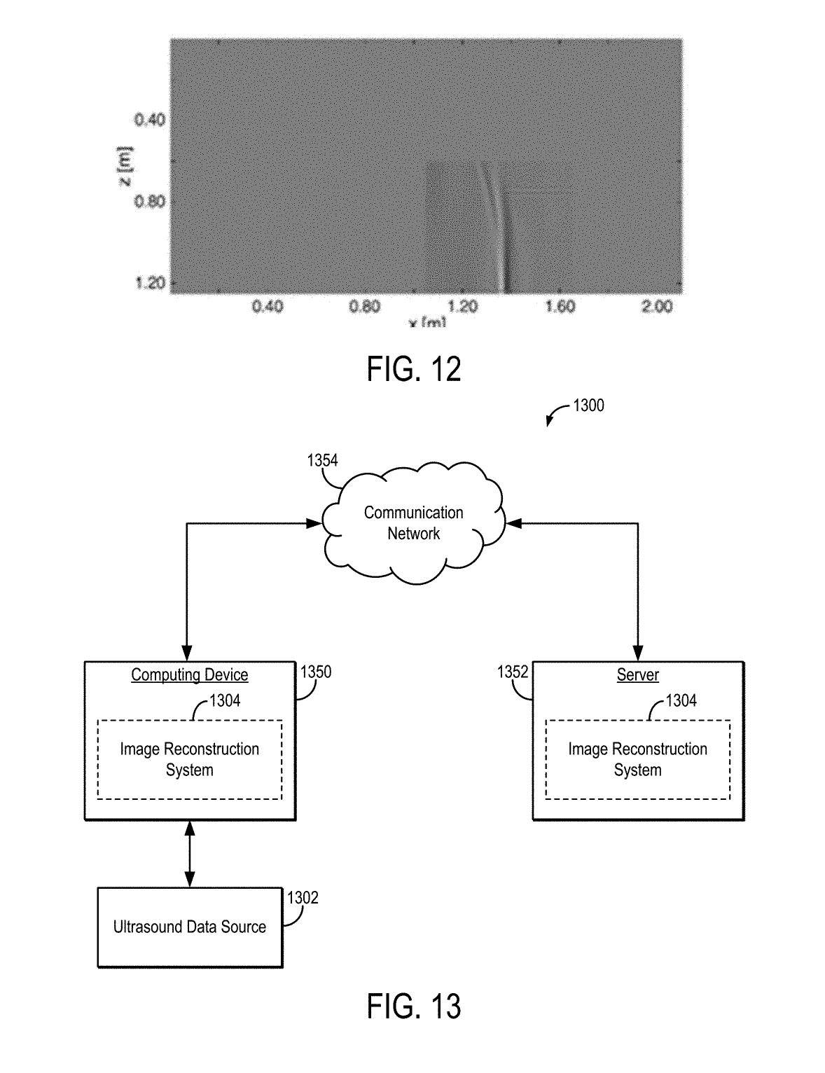

As mentioned above, the analytical RTM enables imaging a region-of-interest that could not be detected in the first trial. The region-of-interest for the stepped foundation is the neighborhood of the vertical boundary. The reconstructed image corresponding to this ROI is shown in FIG. 12. This capability to image an ROI allows a further reduction in computation cost by imaging only the desired part of a domain rather than the entire domain.

In the conventional RTM, the source wavefields are saved in memory after each 10 time steps to alleviate the high memory demand. The analytical approach algorithm was implemented in this example study with a serial FORTRAN code. Low CPU and memory usage of the analytical RTM approach enable performance of nine analyses in parallel; therefore, the memory and CPU usage provided in Table 1 are for nine simultaneous analyses.

To evaluate the efficiency of the proposed analytical RTM approach, its runtime and its CPU and memory usage were compared with that of conventional RTM. A PC with 32 GB of RAM and an Intel® Core i7-4790 CPU @ 3.60 GHz was used to perform the simulations. The results presented in Table 2 show a significant reduction in run time and memory usage.

TABLE 2
Performance Comparison of Analytical and Conventional RTM

| | | | |
|---|---|---|---|
| Pixel size | CPU Usage | Memory Usage | Runtime |

First Trial of Analytical RTM

| | | | |
|---|---|---|---|
| 1 mm × 1 mm | 70% | 360 MB | 190 s |
| 2 mm × 2 mm | 70% | 215 MB | 70 s |
| 4 mm × 4 mm | 70% | 180 MB | 20 s |

First Trial of Conventional RTM

| | | | |
|---|---|---|---|
| 1 mm × 1 mm | 84% | >32,000 MB | >90,720 s |

Second Trial of Analytical RTM

| | | | |
|---|---|---|---|
| 1 mm × 1 mm | 70% | 350 MB | 510 s |
| 2 mm × 2 mm | 70% | 210 MB | 170 s |
| 4 mm × 4 mm | 70% | 175 MB | 45 s |

Second Trial of Conventional RTM

| | | | |
|---|---|---|---|
| 1 mm × 1 mm | 84% | 29,900 MB | 90,720 s |

As can be seen in Table 2, the memory usage was significantly reduced from about 30,000 MB to under 400 MB. The runtime was decreased drastically from 90,720 seconds in each trial to less than 50 seconds when 4 mm×4 mm pixels were used.

An analytical RTM approach was developed and tested to overcome the limitations of the conventional reverse time migration technique and make it affordable for nondestructive testing. The analytical RTM approach described in the present disclosure takes advantage of the asymptotic behavior of the anti-plane shear wave originated from a virtually point source and propagated to a half-space medium. Using fictitious senders simulated reflections from the backwall. The analytical RTM approach described in the present disclosure removes the memory bottleneck and reduces computation time drastically from days to minutes. The obtained results indicate that analytical RTM is comparable to SAFT in terms of efficiency. The efficiency of this method allows using it in practice to locate steep interfaces and bottom boundaries of inclusions or defects. Moreover, 3D reconstructed images can be obtained in a feasible time. The analytical RTM approach described in the present disclosure can be applied to transducer transmitting longitudinal waves as well.

Referring now to FIG. 13, an example of a system 1300 for reconstructing an image from ultrasound data using an analytical reverse time migration (“RTM”) algorithm in accordance with some embodiments of the systems and methods described in the present disclosure is shown. As shown in FIG. 13, a computing device 1350 can receive one or more types of data (e.g., ultrasound data) from ultrasound data source 1302, which may be an ultrasound data source. In some embodiments, computing device 1350 can execute at least a portion of an image reconstruction system 1304 to reconstruct images from ultrasound data received from the ultrasound data source 1302.

Additionally or alternatively, in some embodiments, the computing device 1350 can communicate information about data received from the ultrasound data source 1302 to a server 1352 over a communication network 1354, which can execute at least a portion of the image reconstruction system 1304 to reconstruct images from data received from the ultrasound data source 1302. In such embodiments, the server 1352 can return information to the computing device 1350 (and/or any other suitable computing device) indicative of an output of the image reconstruction system 1304 to reconstruct images from data received from the ultrasound data source 1302.

In some embodiments, computing device 1350 and/or server 1352 can be any suitable computing device or combination of devices, such as a desktop computer, a laptop computer, a smartphone, a tablet computer, a wearable computer, a server computer, a virtual machine being executed by a physical computing device, and so on. The computing device 1350 and/or server 1352 can also reconstruct images from the data.

In some embodiments, ultrasound data source 1302 can be any suitable source of ultrasound data (e.g., measurement data), such as an ultrasound system, another computing device (e.g., a server storing ultrasound data), and so on. In some embodiments, ultrasound data source 1302 can be local to computing device 1350. For example, ultrasound data source 1302 can be incorporated with computing device 1350 (e.g., computing device 1350 can be configured as part of a device for capturing, scanning, and/or storing ultrasound data). As another example, ultrasound data source 1302 can be connected to computing device 1350 by a cable, a direct wireless link, and so on. Additionally or alternatively, in some embodiments, ultrasound data source 1302 can be located locally and/or remotely from computing device 1350, and can communicate data to computing device 1350 (and/or server 1352) via a communication network (e.g., communication network 1354).

In some embodiments, communication network 1354 can be any suitable communication network or combination of communication networks. For example, communication network 1354 can include a Wi-Fi network (which can include one or more wireless routers, one or more switches, etc.), a peer-to-peer network (e.g., a Bluetooth network), a cellular network (e.g., a 3G network, a 4G network, etc., complying with any suitable standard, such as CDMA, GSM, LTE, LTE Advanced, WiMAX, etc.), a wired network, and so on. In some embodiments, communication network 108 can be a local area network, a wide area network, a public network (e.g., the Internet), a private or semi-private network (e.g., a corporate or university intranet), any other suitable type of network, or any suitable combination of networks. Communications links shown in FIG. 13 can each be any suitable communications link or combination of communications links, such as wired links, fiber optic links, Wi-Fi links, Bluetooth links, cellular links, and so on.

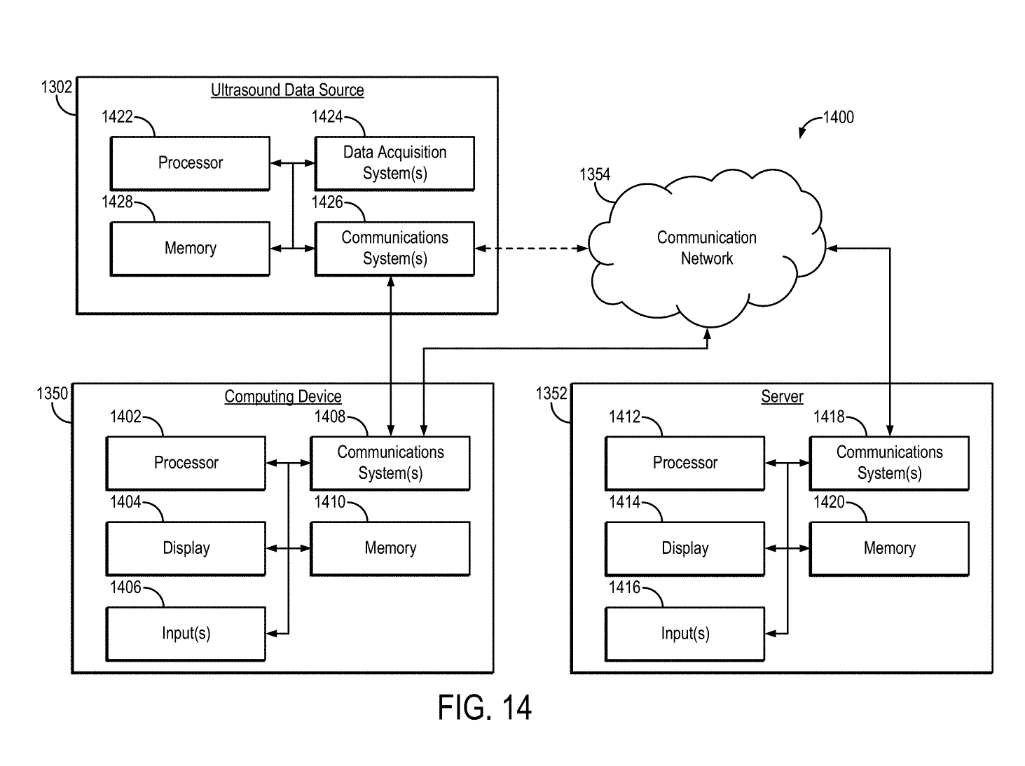

Referring now to FIG. 14, an example of hardware 1400 that can be used to implement ultrasound data source 1302, computing device 1350, and server 1354 in accordance with some embodiments of the systems and methods described in the present disclosure is shown. As shown in FIG. 14, in some embodiments, computing device 1350 can include a processor 1402, a display 1404, one or more inputs 1406, one or more communication systems 1408, and/or memory 1410. In some embodiments, processor 1402 can be any suitable hardware processor or combination of processors, such as a central processing unit (“CPU”), a graphics processing unit (“GPU”), and so on. In some embodiments, display 1404 can include any suitable display devices, such as a computer monitor, a touchscreen, a television, and so on. In some embodiments, inputs 1406 can include any suitable input devices and/or sensors that can be used to receive user input, such as a keyboard, a mouse, a touchscreen, a microphone, and so on.

In some embodiments, communications systems 1408 can include any suitable hardware, firmware, and/or software for communicating information over communication network 1354 and/or any other suitable communication networks. For example, communications systems 1408 can include one or more transceivers, one or more communication chips and/or chip sets, and so on. In a more particular example, communications systems 1408 can include hardware, firmware and/or software that can be used to establish a Wi-Fi connection, a Bluetooth connection, a cellular connection, an Ethernet connection, and so on.

In some embodiments, memory 1410 can include any suitable storage device or devices that can be used to store instructions, values, data, or the like, that can be used, for example, by processor 1402 to present content using display 1404, to communicate with server 1352 via communications system(s) 1408, and so on. Memory 1410 can include any suitable volatile memory, non-volatile memory, storage, or any suitable combination thereof. For example, memory 1410 can include RAM, ROM, EEPROM, one or more flash drives, one or more hard disks, one or more solid state drives, one or more optical drives, and so on. In some embodiments, memory 1410 can have encoded thereon, or otherwise stored therein, a computer program for controlling operation of computing device 1350. In such embodiments, processor 1402 can execute at least a portion of the computer program to present content (e.g., images, user interfaces, graphics, tables), receive content from server 1352, transmit information to server 1352, and so on.

In some embodiments, server 1352 can include a processor 1412, a display 1414, one or more inputs 1416, one or more communications systems 1418, and/or memory 1420. In some embodiments, processor 1412 can be any suitable hardware processor or combination of processors, such as a CPU, a GPU, and so on. In some embodiments, display 1414 can include any suitable display devices, such as a computer monitor, a touchscreen, a television, and so on. In some embodiments, inputs 1416 can include any suitable input devices and/or sensors that can be used to receive user input, such as a keyboard, a mouse, a touchscreen, a microphone, and so on.

In some embodiments, communications systems 1418 can include any suitable hardware, firmware, and/or software for communicating information over communication network 1354 and/or any other suitable communication networks. For example, communications systems 1418 can include one or more transceivers, one or more communication chips and/or chip sets, and so on. In a more particular example, communications systems 1418 can include hardware, firmware and/or software that can be used to establish a Wi-Fi connection, a Bluetooth connection, a cellular connection, an Ethernet connection, and so on.

In some embodiments, memory 1420 can include any suitable storage device or devices that can be used to store instructions, values, data, or the like, that can be used, for example, by processor 1412 to present content using display 1414, to communicate with one or more computing devices 1350, and so on. Memory 1420 can include any suitable volatile memory, non-volatile memory, storage, or any suitable combination thereof. For example, memory 1420 can include RAM, ROM, EEPROM, one or more flash drives, one or more hard disks, one or more solid state drives, one or more optical drives, and so on. In some embodiments, memory 1420 can have encoded thereon a server program for controlling operation of server 1352. In such embodiments, processor 1412 can execute at least a portion of the server program to transmit information and/or content (e.g., data, images, a user interface) to one or more computing devices 1350, receive information and/or content from one or more computing devices 1350, receive instructions from one or more devices (e.g., a personal computer, a laptop computer, a tablet computer, a smartphone), and so on.

In some embodiments, ultrasound data source 1302 can include a processor 1422, one or more data acquisition systems 1424, one or more communications systems 1426, and/or memory 1428. In some embodiments, processor 1422 can be any suitable hardware processor or combination of processors, such as a CPU, a GPU, and so on. In some embodiments, the one or more data acquisition systems 1424 are generally configured to acquire data, images, or both, and can include an ultrasound transducer. As described above, in some embodiments the ultrasound transducer can include a dry point contact (“DPC”) transducer or other transducer that emits horizontal shear waves. Additionally or alternatively, in some embodiments, one or more data acquisition systems 1424 can include any suitable hardware, firmware, and/or software for coupling to and/or controlling operations of an ultrasound transducer. In some embodiments, one or more portions of the one or more data acquisition systems 1424 can be removable and/or replaceable.

Note that, although not shown, ultrasound data source 1302 can include any suitable inputs and/or outputs. For example, ultrasound data source 1302 can include input devices and/or sensors that can be used to receive user input, such as a keyboard, a mouse, a touchscreen, a microphone, a trackpad, a trackball, and so on. As another example, ultrasound data source 1302 can include any suitable display devices, such as a computer monitor, a touchscreen, a television, etc., one or more speakers, and so on.

In some embodiments, communications systems 1426 can include any suitable hardware, firmware, and/or software for communicating information to computing device 1350 (and, in some embodiments, over communication network 1354 and/or any other suitable communication networks). For example, communications systems 1426 can include one or more transceivers, one or more communication chips and/or chip sets, and so on. In a more particular example, communications systems 1426 can include hardware, firmware and/or software that can be used to establish a wired connection using any suitable port and/or communication standard (e.g., VGA, DVI video, USB, RS-232, etc.), Wi-Fi connection, a Bluetooth connection, a cellular connection, an Ethernet connection, and so on.

In some embodiments, memory 1428 can include any suitable storage device or devices that can be used to store instructions, values, data, or the like, that can be used, for example, by processor 1422 to control the one or more data acquisition systems 1424, and/or receive data from the one or more data acquisition systems 1424; to reconstruct images from data; to present content (e.g., images, a user interface) using a display; to communicate with one or more computing devices 1350; and so on. Memory 1428 can include any suitable volatile memory, non-volatile memory, storage, or any suitable combination thereof. For example, memory 1428 can include RAM, ROM, EEPROM, one or more flash drives, one or more hard disks, one or more solid state drives, one or more optical drives, and so on. In some embodiments, memory 1428 can have encoded thereon, or otherwise stored therein, a program for controlling operation of ultrasound data source 1302. In such embodiments, processor 1422 can execute at least a portion of the program to generate images, transmit information and/or content (e.g., data, images) to one or more computing devices 1350, receive information and/or content from one or more computing devices 1350, receive instructions from one or more devices (e.g., a personal computer, a laptop computer, a tablet computer, a smartphone, etc.), and so on.

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (e.g., hard disks, floppy disks), optical media (e.g., compact discs, digital video discs, Blu-ray discs), semiconductor media (e.g., random access memory (“RAM”), flash memory, electrically programmable read only memory (“EPROM”), electrically erasable programmable read only memory (“EEPROM”)), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

The present disclosure has described one or more preferred embodiments, and it should be appreciated that many equivalents, alternatives, variations, and modifications, aside from those expressly stated, are possible and within the scope of the invention.

1. A method for producing an image of an object, the steps of the method comprising:
(a) scanning the object with an ultrasound transducer comprising a plurality of transducer elements in order to obtain ultrasound data;
(b) forming an image matrix corresponding to a region in the object from which ultrasound data were acquired;
(c) reconstructing an image from the ultrasound data by applying an analytical reverse time migration algorithm to each pixel in the image matrix, thereby assigning a pixel value to each pixel in the image matrix.

2. The method as recited in claim 1, wherein applying the analytical RTM algorithm comprises for a given pixel in the image matrix:
computing distance data between the pixel and each of source locations, receiver locations, fictitious source locations, and fictitious receiver locations, the distance data thereby comprising source distance data, receiver distance data, fictitious source distance data, and fictitious receiver distance data;
computing travel time data of waves between the pixel and each of the source locations, receiver locations, fictitious source locations, and fictitious receiver locations, using the distance data, the travel time data thereby comprising source travel time data, receiver travel time data, fictitious source travel time data, and fictitious receiver travel time data;
computing source response data using the source distance data, fictitious source distance data, the source travel time data, and the fictitious source travel time data;
computing receiver response data using the receiver distance data, the fictitious receiver distance data, the receiver travel time data, and the fictitious receiver travel time data; and
computing a pixel value for the pixel by computing a cross-correlation between the source response data and the receiver response data.

3. The method as recited in claim 2, wherein the source response data comprise velocity data computed using the source distance data, fictitious source distance data, the source travel time data, and the fictitious source travel time data.

4. The method as recited in claim 2, wherein the receiver response data comprise velocity data computed using the receiver distance data, the fictitious receiver distance data, the receiver travel time data, and the fictitious receiver travel time data.

5. The method as recited in claim 4, wherein the receiver response data are computed based on time-reversed signals emitted at the receiver locations and the fictitious receiver locations.

6. The method as recited in claim 2, wherein computing the pixel value for the pixel comprises computing the cross-correlation between the source response data and the receiver response data looped over all available time steps.

7. The method as recited in claim 2, wherein reconstructing the image from the ultrasound data by applying the analytical reverse time migration algorithm to each pixel in the image matrix comprises:
decomposing the source response data into downgoing source wavefield data and upgoing source wavefield data;
decomposing the receiver response data into downgoing receiver response data and upgoing receiver response data; and
wherein computing the cross-correlation between the source response data and the receiver response data comprises computing a sum of:
a first cross-correlation between the downgoing source response data and the downgoing receiver response data;
a second cross-correlation between the downgoing source response data and the upgoing receiver response data;
a third cross-correlation between the upgoing source response data and the downgoing receiver response data; and
a fourth cross-correlation between the upgoing source response data and the upgoing receiver response data.

8. The method as recited in claim 7, further comprising:
identifying artifact sources using the downgoing source wavefield data, upgoing source wavefield data, downgoing receiver response data, and upgoing receiver response data; and
adjusting an amplitude of the reconstructed pixel value to reduce artifacts associated with the identified artifact sources.

9. The method as recited in claim 7, further comprising reducing noise in the reconstructed pixel value by replacing data associated with a bottom boundary of the object with zero values when computing the first cross-correlation and the fourth cross-correlation.

10. The method as recited in claim 7, further comprising reducing noise in the reconstructed pixel value by applying a weight function to the first cross-correlation and to the fourth cross-correlation.

11. The method as recited in claim 10, wherein the weight function is,
$$w ( θ ) = \{ \begin{matrix}1 & θ < {θ}_{t} \\ {( \frac{π / 2 - θ}{π / 2 - {θ}_{t}} )}^{2} & {θ}_{t} \leq θ \leq π / 2\end{matrix} ;$$
wherein θ is an angle between an upgoing wavefield and a downgoing wavefield, and θₜ is a threshold angle value.

12. The method as recited in claim 7, wherein:
the first cross-correlation is normalized based on transmitting a source wavelet from each source location to each receiver location;
the second cross-correlation is normalized based on transmitting a source wavelet from each source location to each fictitious receiver location;
the third cross-correlation is normalized based on transmitting a source wavelet from each fictitious source location to each receiver location; and
the fourth cross-correlation is normalized based on transmitting a source wavelet from each fictitious source location to each fictitious receiver location.

13. The method as recited in claim 7, wherein each of the first cross-correlation, the second cross-correlation, the third cross-correlation, and the fourth cross-correlation are modified using a respective first, second, third, and fourth modification factors to modify an amplitude of the reconstructed pixel value to account for scattering attenuation in the object.

14. The method as recited in claim 13, wherein:
$$the first modification factor comprises {10}^{( \frac{α ( {r}_{S} + {r}_{FR} )}{20} )} ;$$
$$the second modification factor comprises {10}^{( \frac{α ( {r}_{S} + {r}_{R} )}{20} )} ;$$
$$the third modification factor comprises {10}^{( \frac{α ( {r}_{FS} + {r}_{FR} )}{20} )} ;$$
$$the fourth modification factor comprises {10}^{( \frac{α ( {r}_{FS} + {r}_{R} )}{20} )} ;$$
wherein α is an attenuation coefficient for a medium in the object, r_{S} is a distance between a source and the pixel, r_{FR} is a distance between a fictitious receiver and the pixel, r_{R} is a distance between a receiver and the pixel, and r_{FS} is a distance between a fictitious source and the pixel.

15. The method as recited in claim 1, wherein scanning the object comprises generating horizontal shear waves in the object using the ultrasound transducer.

16. The method as recited in claim 15, wherein the ultrasound transducer comprises a dry point contact (DPC) transducer.
